(19) United States
(12) Patent Application Publication
(10) Pub. No.: US 2015/0333491 A1
(43) Pub. Date: Nov. 19, 2015

(54) ALTERNATIVE ENERGY BUS BAR BY PASS BREAKER

(71) Applicant: Paul Cruz, San Diego, CA (US)

(72) Inventor: Paul Cruz, San Diego, CA (US)

(21) Appl. No.: 14/276,217

(22) Filed: May 13, 2014

(51) Int. Cl. H02B 1/20; H02B 1/03

(52) U.S. Cl. CPC H02B 1/20; H02B 1/03

(57) ABSTRACT

The present invention is directed, in part, to electrical components and methods of use associated with such components. In particular, the invention relates to an electrical device and improved method of back feeding energy generated from alternative energy devices such as solar panels, wind turbines, fuel cells, electrical generators and other alternative energy sources, to the utility without the necessity of installing a sub panel or replacing an existing panel, resulting in significant cost savings for the user and increased electrical energy available to the power grid.

### FIELD OF THE INVENTION

The present invention relates generally to electrical components and methods of use associated with such components. In particular, the invention relates to an electrical device and improved method of back feeding energy generated from alternative energy devices such as solar panels, wind turbines, fuel cells, electrical generators and other alternative energy sources, to the utility without the necessity of installing a sub panel or replacing an existing main panel, resulting in significant cost savings for the user and increased electrical energy availability to the power grid.

### BACKGROUND OF THE INVENTION

Traditionally, the circuit breaker is designed to be the weak link in a home or commercial electrical system and designed to fail safely. In the event a circuit draws more current than it is designed to handle, the corresponding wiring gets hot and problems can occur including fires. The use of so-called “overcurrent” safety devices such as the circuit breaker are designed to prevent such fires by breaking the circuit and stopping the occurrence of heat build due to a greater than expected level of electrical current. Circuit breakers connect to the hot bus bars and come in a variety of types and capacities.

Single Pole Breakers provide 120 volts and typically come in ratings of 15 to 20 amps. These breakers make up the majority of breakers in a standard home. Double Pole Breakers provide 240 volts and typically come in ratings from 15 to 50 amps. These breakers generally serve dedicated circuits for large appliances such as electric dryers, stoves and air conditioners.

The service main panel is typically configured with two bus bars (L₁, L₂ and a ground neutral bar) typically comprised of a thick strip of copper or aluminum that conducts electricity within a distribution board, switchboard, substation or any other electrical apparatus. Bus bars are typically used to carry or dispense very large currents to several devices that are inside the switchgear such as to home appliances or other electricity consuming apparatus.

Modernly, remodeling and installation of alternative energy devices including solar panels, wind turbines or other power generating equipment in a home or commercial building have required either replacing the structure's electrical main panel or installation of a sub panel in order to accommodate the extra load generated by the additional alternative energy devices being installed. Replacement of a new service panel and/or installation of new sub panels to an existing electrical system results in significant expenses to the home or building owner committing the owner to an investment of several years of alternative energy generation to recoup the expense associated with installation of the alternative energy device.

National Electrical Code (NEC) sections 690.64(B)/705.12(D) govern the requirements and limitations of bus bar load. Bus bars are generally intended to deliver electrical power from the main panel to the various circuit breakers that are employed in distribution of power to a residential or commercial dwelling. 705.12(D)(2) provides in part: Buss or Conductor Rating: The Sum of the ampere ratings of overcurrent devices in circuits supplying power to a bus bar or conductor shall not exceed 120 percent of the rating of the bus bar or conductor.

From a practical perspective, regulations that govern electrical power through a bus bar preclude the transfer of such power beyond 120% of the amperage rating of the bus bar. Accordingly, to maintain compliance with regulations, the installation of alternative energy sources to a home or commercial building including solar power, wind turbines and the like, require a complete replacement of the existing main panel, or addition of a sub panel to accommodate excess power back fed to the utility since excess power can potentially overload the amperage rating of the bus bars leading to the risk of fire.

Various devices have sought to address issues in detecting and preventing instances of overcurrent as well as in managing back fed power generated from alternative energy sources to the power grid, however none have fully addressed shortcomings currently existing in the art. For example, U.S. Patent Application number 2012/0300348 describes a circuit breaker and trip logic that includes fault detection within each of a plurality of circuit breakers whereby the trip logic enables tripping options to be selected for each of the circuit breakers. The disclosure however, does not provide a solution relating to the matter of excess power management through bus bars of a specific amperage. More importantly, it fails to address avoiding the necessity of replacement an existing main panel which results in significant time and expense to a home owner or commercial building owner.

U.S. Pat. No. 4,288,78 to Arnhold et al., describes a circuit breaker for interrupting a current circuit in response to an overload current, or a short circuit current, or in response to an earth leakage or fault current. It further describes one or several single pole circuit breakers with an earth leakage current circuit breaker for such overcurrents. It however, does not disclose or suggest a provision for the management of overcurrent through bus bars generated from alternative energy sources such as for example, newly installed solar panels or wind turbine assemblies.

U.S. Pat. No. 4,100,587 describes a circuit configured between a power supply and a load for detecting the flow of excess power from a load back through the supply. The circuit is described as sensing the current flowing between the power supply and the load, and also senses the output voltage from the power supply with further embodiments that act to generate a signal to disconnect the power supply from the load when the average power signal is above a certain threshold. Again, the device and methods fail to address the issue of significant time and expense in installation of alternative energy sources and for avoiding the significant costs and time required in maintaining current within NEC specifications even during instances of overcurrent generated from such alternative energy sources.

Accordingly, difficulties in the field of electrical back feed to the power grid and cost savings associated with the installation of alternative energy sources remain. Existing solutions fail to address particular deficiencies that confront businesses and consumers seeking alternatives to the existing art and a solution to advancing cost and time saving measures for greater implementation of alternative energy options remains elusive. The present invention seeks to address these shortcomings.

### SUMMARY OF THE INVENTION

The present invention is directed to a back feed circuit breaker that is tapped in parallel with power incoming from a power grid and utility. The parallel tap is disposed either between a main circuit breaker (breaker side) of the service panel and the bus bars of the main panel. Alternatively, the parallel tap is disposed between a power meter that is connected to a power utility grid (supply side) and the main circuit breaker, again, prior to the bus bars, which in turn lead to sub breakers that distribute power to a home, building or other structure. The back feed circuit breaker is connected to and manages the power generated from a source of alternative energy, including for example; solar panels, wind turbines, electrical generators or any other alternative energy sources as known in the art wherein the alternative energy source generates excess power that can be transferred back to the power grid and utility, or alternatively, to the structure during times of energy need.

The back feed circuit breaker of the invention is tapped in parallel to power incoming from the utility and configured to create a direct circuit between the back feed circuit breaker and the main panel while by-passing the bus bars of the main circuit breaker in order to back feed power to the utility. In this configuration, excess power generated from the alternative energy source does not pass through the bus bars of the main panel. As excess power is generated by the alternative energy source, a circuit formed by the parallel tap with the main circuit breaker, either configured supply side or breaker side, delivers the excess power to the utility, while the power bypasses the bus bars completely since the bus bars do not form any portion of the circuit.

During instances in which power is needed in the structure, a circuit is created between the back feed circuit breaker, the main circuit breaker and the bus bars which in turn lead to sub-breakers which feed and distribute power to the structure so to deliver power generated from the alternative energy source as needed. In so doing, compliance with NEC regulations relating to bus bar amperage rating is maintained.

The present invention further provides interchangeable sub breakers configured within the main circuit breaker of the invention to allow a user to increase the capacity of alternative energy generation and to install additional alternative energy power sources. In particular, the invention will be configured with a main circuit breaker that employs interchangeable sub breakers that allow for the expansion and upgrade of existing alternative energy sources in the home, building or structure.

Disposed between the main circuit breaker and the one or more bus bars of the main circuit breaker is a parallel tap stemming from a back feed circuit breaker that connects to one or more alternative energy sources including solar panels, wind turbines, gas powered generators or other power generating sources as known in the art. Forming part of the main circuit breaker are interchangeable sub breakers that allow a user to change the amperage allowance of the back feed sub breakers in order to add or improve the alternative energy capacity of a home or commercial building. Upgraded main sub breakers can be installed in order to install additional solar panels either during construction of the structure or years later when additional alternative energy and equipment is desired. The interchangeable main sub breakers allow a user to install upgraded solar panels, wind turbines or electricity generating gas generators into the structure without the need to install sub panels or to replace a service main panel in order to accommodate the upgraded alternative energy sources or the back feed circuit breaker.

The present invention further relates to a novel bus bar clamping mechanism wherein the “hot” and “neutral” lines of a main panel connect and are clamped directly to the bus bars of the main circuit breaker. The prior art generally employs a “spring to bus bar” mechanism wherein the spring terminal is pushed onto the terminal end of the bus bars in order to establish an electrical connection. It is likewise known that in such a configuration, over time, loss of conductance and carbon build up occurs which can result in an increased risk of fire. The present invention addresses that shortcoming by creating a direct and secure connection between the hot lines of a main panel circuit breaker and the bus bars thereby eliminating the carbon build up and corrosion between the terminal springs and bus bars. The present invention is also isolated so electrical shock is eliminated when tightening and clamping bus bars. As part of this embodiment, the invention also includes a heat sensor disposed in the main circuit breaker, which acts to detect instances in which load bearing lines of the main circuit is occurring. The heat sensor is disposed near the bus bar connection to the hot lines.

The present invention further relates to a back feed circuit breaker that manages excess power generated by an alternative energy source wherein power generated by the alternative energy source is tapped in parallel with the hot lines of the main circuit breaker coming from the utility wherein the parallel tap is disposed between the utility meter and the main circuit breaker (supply side). In such a configuration, excess power generated by the alternative energy source is transferred directly to the power grid. During times in which the home or building requires power, the parallel tap delivers power from the alternative energy source to the main panel, and thereafter through the bus bars and to sub breakers to distribute power to the structure.

The present invention further relates to a back feed circuit breaker that manages excess power generated by an alternative energy source wherein the power generated by the alternative energy source is tapped in parallel with the hot lines of the main circuit breaker and is disposed between the main circuit breaker and the bus bars (breaker side). In such a configuration, excess power is delivered directly to the power grid. Alternatively, in times of need, the parallel tap delivers power generated by the alternative energy source to the home or building by transferring the power to the bus bars and onward to sub breakers that distribute power.

### BRIEF DESCRIPTION OF THE DRAWINGS

FIG. 1 depicts the pre-existing art wherein a sub panel is installed in order to accommodate the installation of an alternative energy source such as for example, solar panels.

FIG. 2 depicts a basic configuration of the pre-existing art as it relates to a main service panel wherein a two-pole configuration is shown.

FIG. 3 depicts a basic schematic of an alternative energy source wherein power generated from a photovoltaic source and is transferred to an inverter and thereafter on to a main panel for transfer to the power grid or alternatively, to the home or building structure.

FIG. 4 illustrates an overview of a back feed circuit breaker and parallel tap wherein the parallel tap from the back feed circuit breaker is disposed between the main panel circuit breaker and the bus bars of the main panel.

FIG. 5 illustrates a bus bar clamping mechanism of the invention. In particular, a specially designed screwdriver is employed to connect the hot wires directly and securely to the bus bars. The system is isolated so electric shock is eliminated when tightening and clamping bus bars.

FIG. 6 illustrates the back feed circuit breaker and parallel tap wherein the parallel tap is disposed between the utility meter and the main circuit breaker to the panel (supply side). As shown, the main circuit breaker and the back feed circuit breaker are depicted as 2-pole 240-volt breakers. The figure illustrates a configuration in which the main circuit breaker is not controlling the parallel tap.

FIG. 7 illustrates an alternative design of the back feed circuit breaker wherein the back feed circuit breaker and parallel tap is disposed between the main circuit breaker and the bus bars (breaker side). As shown, the main breaker and back feed circuit breaker are depicted as 2-pole 240-volt breakers. The figure illustrates a configuration in which the main breaker controls the parallel tap.

FIG. 8a illustrates the invention wherein the main circuit breaker is configured in a main panel wherein sub breakers of the main panel are interchangeable. The main and sub breakers are depicted as 2-pole, 240-volt breakers.

FIG. 8b illustrates the invention wherein the main circuit breaker is shown in a side view and configured in a main panel wherein the sub breakers of the main panel are interchangeable. Connection terminals are illustrated.

FIG. 9a illustrates the invention wherein the main circuit breaker is configured in a main panel wherein sub breakers of the main panel are fixed. As shown, the sub-breakers comprise sub breakers that manage power generated from an alternative energy source. The main and sub breakers are depicted as 2-pole, 240-volt breakers

FIG. 9b illustrates the invention wherein the main circuit breaker is shown in a side view and configured in a main panel wherein the sub breakers of the main panel are fixed. The main and sub breakers are depicted as 2-pole, 240-volt breakers. Connection terminals are illustrated.

FIG. 10 illustrates the main circuit breaker and one or more interchangeable sub breakers of the invention. As shown, the figure illustrates one or more interchangeable sub circuit breakers that are connected to a main circuit breaker with the main and sub breakers depicted as 2-pole, 240-volt breakers. Also provided is a side view of the main circuit breaker and one or more interchangeable sub breakers with terminal connections provided.

FIG. 11 illustrates the main circuit breaker and one or more fixed sub breakers connected to the main circuit breaker. As illustrated, one or more fixed sub breakers are connected to a main circuit breaker in order to accommodate upgraded alternative energy sources installed into the home or structure. Also provided is a side view of the main circuit breaker and one or more fixed back feed circuit breakers with terminal connections provided. The main and sub breakers are depicted as 2-pole, 240-volt breakers.

FIG. 12 illustrates a general depiction of the invention. In particular, the schematic illustrates power in from the utility wherein the power is delivered to the main circuit breaker of the main panel via 2-pole 240-volt breaker. Further provided is the back feed circuit breaker that is tapped in parallel with the hot lines of the main circuit breaker. As depicted, the parallel tap is controlled by the main circuit breaker wherein the parallel tap is disposed between the main circuit breaker and the bus bars. The parallel tap delivers excess power (i.e., backfed power) to the utility or alternatively, during times of need, the power is transferred to the main circuit breaker, then on to the bus bars and transferred to sub breakers which distribute the power to the structure.

### DETAILED DESCRIPTION OF THE INVENTION

The present invention is directed to a novel bus bar by pass circuit breaker and method of back feeding excess power to the power grid wherein power generated by an alternative energy device such as for example, solar panels, wind turbines and the like is transferred to a back feed circuit breaker that is tapped in parallel to the lines of a main circuit breaker while by-passing the bus bars of the circuit breaker. As part of the invention, the parallel tap is disposed between the main circuit breaker of a main service panel and the bus bars of the main service panel (breaker side) so power is never passed through the bus bars. In other words, power generated by the alternative energy source bypasses the bus bars and is delivered directly to the utility power grid.

Alternatively, the parallel tap is disposed between the power grid and the main circuit breaker of the invention (supply side). Again, the power generated by the alternative energy source never passes through the bus bars and is delivered directly to the power grid. The back feed circuit breaker is connected to and manages the power generated from a source of alternative energy including for example, solar panels, wind turbines, electrical generators or any other alternative energy sources as known in the art. The power generated by the alternative energy source is transferred to the power grid and utility by means of a parallel tap with the main circuit breaker with power by-passing the bus bars of the main circuit breaker when delivered to the power grid. Alternatively, during times of energy need the power generated by the alternative energy source is delivered to the sub breakers and bus bars of the main circuit breaker and transferred to the home, building or structure.

The invention described herein is a back feed system and a method of back feeding power to the utility power grid that includes, a main service panel wherein the main service panel includes a main circuit breaker, a back feed circuit breaker and one or more bus bars wherein, the back feed circuit breaker is in parallel tap with the main circuit breaker and wherein said parallel tap is disposed between the main circuit breaker and the one or more bus bars. In such a configuration, the parallel tap is controlled by the main circuit breaker. The back feed circuit breaker is connected to an alternative energy source, wherein the alternative energy source generates electricity referred to herein as backfed power. The alternative energy source delivers the backfed power to the back feed circuit breaker wherein, the backfed power is then delivered by the back feed circuit breaker by parallel tap to the main circuit breaker. The backfed power is delivered to a utility power grid wherein, the backfed power bypasses the one or more bus bars and the bus bars do not form any portion of the circuit with said backfed power. Alternatively, during times of energy need, the backfed power is delivered to the one or more bus bars wherein the backfed power is thereafter delivered to a structure in order to power electrical components installed within the structure.

The back feed system also includes an alternative embodiment wherein the back feed circuit breaker is in parallel tap with the main circuit breaker wherein the parallel tap is disposed between a utility meter and the main circuit breaker. As part of the embodiment the parallel tap is not controlled by the main circuit breaker. In this embodiment backfed power is delivered to a utility power grid wherein the backfed power bypasses the one or more bus bars and the bus bars do not form any portion of the circuit with the backfed power. One or more back feed circuit breakers are envisioned within the scope of the invention to accommodate numerous alternative energy sources and equipment.

The invention further describes a back feed system that includes a one-phase, two-phase or three-phase electrical system including wiring lugs for each of the phase configurations. Further, the scope of the invention includes a main circuit breaker that is either a single or double pole circuit breaker. Other pole breakers are included as known in the art. As an alternative to the parallel tap, the invention also employs a “T” tap.

The invention further discloses a novel clamping mechanism that employs a securing means that connects the hot lines of the main circuit breaker to the bus bars in order to form a secure and direct connection thus, reducing the risk of corrosion between the bus bars and the hot lines and therefore reducing the overall risk of fire. Also included is a heat sensor located near the bus bar connection to detect the presence of overheating and to act as a fire or smoke detector, the heat sensor tripping the circuit breaker when excess heat or fire is detected.

It is therefore, a primary object of the present invention to provide a back feed circuit breaker and methods of use that effectively manage excess power generated by an alternative energy source so that excess power is backfed directly to the power grid whereupon the excess power by-passes the bus bars of a main panel circuit breaker thereby ensuring compliance with NEC regulations relating to maintaining bus bar amperage with back fed energy. The present invention assures compliance with existing NEC regulations since excess power generated by the alternative energy source never passes through the bus bars of the main circuit breaker on its way to the utility power grid as is typical in the art, but rather is delivered directly to the power grid, by-passing the bus bars altogether. Alternatively, during times of energy need power generated by the alternative energy device is delivered to the bus bars and onward to sub breakers for distribution to the home or building structure.

In a preferred embodiment, the invention includes a main circuit breaker, one or more bus bars and a back feed circuit breaker wherein the back feed circuit breaker is connected to an alternative energy source and manages power generated from such a source. Power generated by the alternative energy source is delivered to the utility power grid by means of a parallel tap with the main circuit breaker wherein the parallel tap is disposed between the main circuit breaker and the bus bars. Accordingly, excess power generated by the alternative energy source by-passes the bus bars of the main circuit breaker and is delivered directly to the utilit power grid.

Alternatively, the parallel tap is disposed between the utility power grid and the main circuit breaker. In such a configuration, power generated from the alternative energy source is delivered from the back feed circuit breaker and is transferred directly to the power grid, by-passing the bus bars of the main circuit breaker altogether. In times of need, power from the alternative energy source is transferred to the main circuit breaker, to the bus bars and on to sub breakers for distribution to areas of the home requiring power.

As part of the preferred embodiment, the back feed circuit breaker employs either interchangeable or fixed sub breakers in the main circuit breaker that distribute and manage power generated from the alternative energy source and which also allow for easy upgrading and installation of alternative energy sources as needed. To upgrade and install additional alternative energy sources in a home or building, a user installs interchangeable sub breakers with high amperage sub breakers so that additional alternative energy sources can be readily and easily installed without the need for rewiring or installation of sub panels.

In yet another preferred embodiment of the invention, the invention includes a main circuit breaker and a back feed circuit breaker which is tapped in parallel wherein the parallel tap is disposed between the main circuit breaker and the bus bars of the main circuit breaker so that power generated by the alternative energy source by-passes the bus bars of the main circuit breaker and power delivered directly to the utility power grid. In a related embodiment, power generated by the alternative energy source is connected in parallel with the hot lines of the main circuit breaker wherein the parallel tap is disposed between the power grid/power meter and the main circuit breaker, by-passing the bus bars of the main circuit breaker altogether. In such a configuration, the back feed circuit breaker is connected to an alternative energy source with power generated by the alternative delivered to either the utility power grid, in times when power is in excess supply, or alternatively, to the home or building, in times when the building or home structure is in need of power from the alternative energy source.

In a preferred embodiment, the present invention includes a main circuit breaker and one or more bus bars connected to the main circuit breaker and also includes an alternative energy source that delivers excess electricity to the power grid or alternatively, to a home or building during times of need through a back feed circuit breaker that is connected in parallel with the hot lines of the main circuit breaker. The main circuit breaker is employed with either a single or double pole circuit breaker.

As part of the preferred embodiment of the invention, the main service panel will employ a 1, 2 or 3-phase circuit breaker. It will be understood by those in the art that 3-phase circuit breakers provide greater efficiency due to the delta of 120 degrees out of phase. Accordingly, a 3-phase circuit breaker is envisioned and within the scope of the present invention.

As used herein, the term “connected” refers to the general and known understanding of the term as it relates to the electrical field. For example, understanding of the term includes an electrical connection between two electrical components wherein either an electrical circuit is created when power is present or alternatively, a circuit is interrupted under certain circumstances wherein the electrical components no longer connected to form a circuit to carry power.

As used herein the terms “disposed between”, “disposed” refer to the position of a first electrical component, wherein the first electrical component is connected to one or more other electrical components wherein the first electrical component is electrically connected and configured between the other electrical components wherein an electrical circuit can be created. The term also includes the position by which a parallel tap connection is located. In particular, a parallel tap connection can be located and configured to be disposed between the main circuit breaker of the invention and the bus bars. For example, a parallel tap connection can be disposed between the power grid and the main circuit breaker of the invention thus, bypassing the bus bars of the main circuit breaker or alternatively, the parallel tap can be disposed between the main circuit breaker and the bus bars of the main circuit breaker so that in either case, power delivered from the alternative energy source to the grid by-passes the bus bars of the main circuit breaker.

The term “back feed circuit breaker” refers to an element of the invention that includes a circuit breaker that manages the power generated from an alternative energy source such as for example, wind turbines, solar panels and other sources of the like wherein the power generated by the source delivers the power either to the utility power grid or alternatively, to a home or building by parallel tap connection to the hot lines of the main circuit breaker. Likewise, the term “back feed power”, “backfed power” or the like as used herein relates to power that is generated from an alternative energy source and is thereafter delivered either to the power grid or alternatively, to a home or building via a main panel circuit breaker by means of a parallel tap connection.

The term “delivered” as used herein refers to the transfer of electricity to electrical components of the invention or delivery of electrical power to main circuit or sub breakers installed in a service panel or building by means of an electrical connection. For example, delivery of electricity as used herein refers to the transfer of electricity from for example, an alternative energy source to a back feed circuit breaker by means of an electrical connection. The term is also referred to herein and understood in its typical sense as that understanding relates to delivery of electricity.

The term “structure” as used herein refers to any home, building or other structure that employs use of electricity and electrical components including but not limited to circuit breakers, power outlets, sub-breakers and which employs use of electricity in order to power electrical components therein. Examples of structures include but are not limited to homes, commercial buildings and other man made structures of the like and kind. The term is also referred to herein and understood in its typical sense.

The terms “utility”, “utility power grid”, “power grid” and terms of the like as used herein, are to be understood in their typical sense and more specifically, refer to a utility company that generates and provides electricity to the general public.

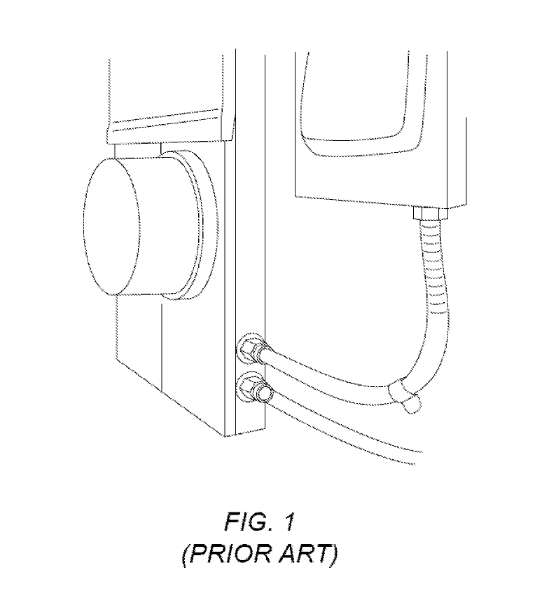

Turning now to the substance of FIGS. 1 to 12 and the preferred embodiments of the invention. FIG. 1 illustrates the known art wherein a main service panel is employed to service the electrical needs of a home or building. To install alternative energy sources and equipment such as for example, solar panels, wind turbines, electrical generators and the like, a sub panel must also be installed or the main service panel must be replaced altogether. The sub panel manages the electricity generated by the solar panel or alternative energy device and must be installed adjacent to the main service panel requiring installation by a licensed and trained electrician.

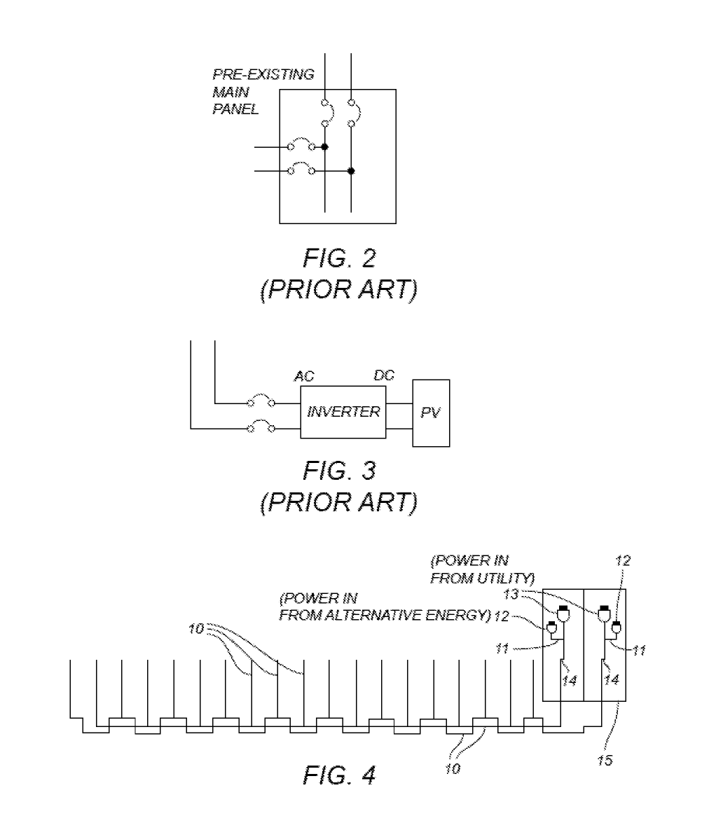

FIG. 2 illustrates a schematic of a pre-existing main service panel. Specifically, as shown, power enters the main panel at the top of the panel in two phases of 120 volts of alternating current. As shown, a main circuit breaker manages the power coming from the utility and transfers the power to sub breakers in the main panel.

FIG. 3 illustrates a typical electrical schematic of a circuit associated with a photovoltaic electrical generator. As shown, solar panels generate electricity as direct current (DC) wherein the power is converted to alternating current (AC) by an inverter and transferred to the main service panel and bus bars for transfer to the power grid.

FIG. 4 illustrates a preferred embodiment of the invention. Specifically, the figure illustrates an electrical schematic of the invention and includes a main circuit breaker 13, a back feed circuit breaker 12 that manages the power generated from an alternative energy source and bus bars connected to the main circuit breaker 10. The figure depicts the main service panel 15 of the invention wherein power enters from the utility at the main circuit breaker 13 in two, 120 V, A and B phases. Power from the utility is transferred from the main circuit breaker 13 to the bus bars 10. Further, one or more alternative energy circuit breakers are tapped in parallel 12 wherein the parallel tap 11 is disposed between the main circuit breaker and the bus bars. The parallel tap connecting one or more alternative energy circuit breakers is disposed between the main circuit breaker and the point of connection to the bus bars 14 and the bus bars 10 so that power transferred from the alternative energy source by-passes the bus bars of the main circuit breaker and is delivered directly to the power grid. In such a configuration, power generated by the one or more alternative energy circuit breakers is transferred to the main circuit breaker and by-passes the bus bars, going directly to the power grid without passing through the bus bars.

Reference 11 illustrates the point at which the bus bars of the main circuit breaker are by-passed and power sent directly to the power grid. Accordingly, power generated by the alternative energy source by passes the bus bars except during times of energy need when the structure requires power generated by the alternative energy source. Power is generated by the alternative energy source, transferred to the alternative energy circuit breaker and thereafter, directly to the main circuit breaker for delivery to the power grid, with power from the alternative energy source by-passing the bus bars of the main circuit breaker altogether, thereby maintaining compliance with NEC codes and amperage rating of the bus bars.

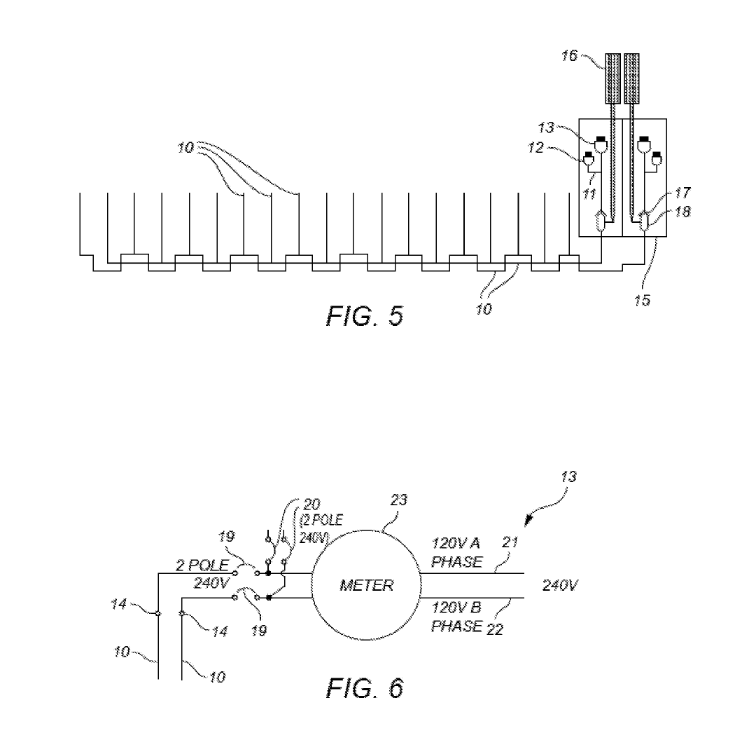

FIG. 5 illustrates a preferred embodiment of the invention wherein the bus bars 10 of the main circuit breaker are directly and securely connected 17 to the load lines of the main circuit breaker. As shown, the bus bars are connected to the main circuit breaker by means of a tool or mechanism of the invention 16 that directly and securely attaches the bus bars to the lines of the main circuit breaker so that there is a constant connection 17, 18. Typical bus bars typically possess a passive connection wherein a spring/bus connection is formed however, generally there is no direct and secure connection between the two elements resulting in movement between the elements, resulting in carbon build up and increased risk of fire. The novel and specially designed clamping mechanism allows a direct, secure connection between the lines of the main circuit breaker and the bus bars so that carbon build up is minimized and risk of fire is greatly diminished.

FIG. 6 illustrates an alternative embodiment of the invention. Specifically, the illustration provides incoming power from the utility 13 in two, 120-volt phases, A and B, 21, 22, with a total of 240 volts entering from the utility. The power from the power grid enters the home or building via a power meter 23. An alternative energy circuit breaker 20 comprising a 2-pole 240-volt breaker is tapped in parallel with the main circuit breaker 19 wherein the parallel tap is disposed between the power meter and the main two-pole, 240-volt circuit breaker 19 (i.e., main circuit breaker). As shown, the alternative energy circuit breaker is in parallel tap with the main circuit breaker wherein the parallel tap is disposed between the power grid and the bus bars 10 and the point of bus bar connection 14 (supply side parallel tap). In this configuration, the main circuit breaker does not control the parallel tap.

The alternative energy circuit breaker is connected to and manages power generated from an alternative energy source such as for example, a solar panel assembly, wind turbines or other alternative energy equipment as known in the art. As excess power is generated by the alternative energy source and delivered to the alternative energy circuit breaker, the power is sent either to the power grid, when power is not needed in the home or structure, or alternatively, to the bus bars 10 for delivery to sub breakers that distribute power to various areas of the home, building or structure. As shown in FIG. 6, in this alternative embodiment, the alternative energy circuit breaker 20 is disposed prior to both the main circuit breaker 19 and the bus bars 10. Accordingly, power generated by the alternative energy source, when being directed to the power grid, bypasses the bus bars of the main circuit panel entirely. In times when the home, building or structure require power, electricity generated by the alternative energy source is directed through the bus bars and sent on to the sub breakers of the home, building or structure.

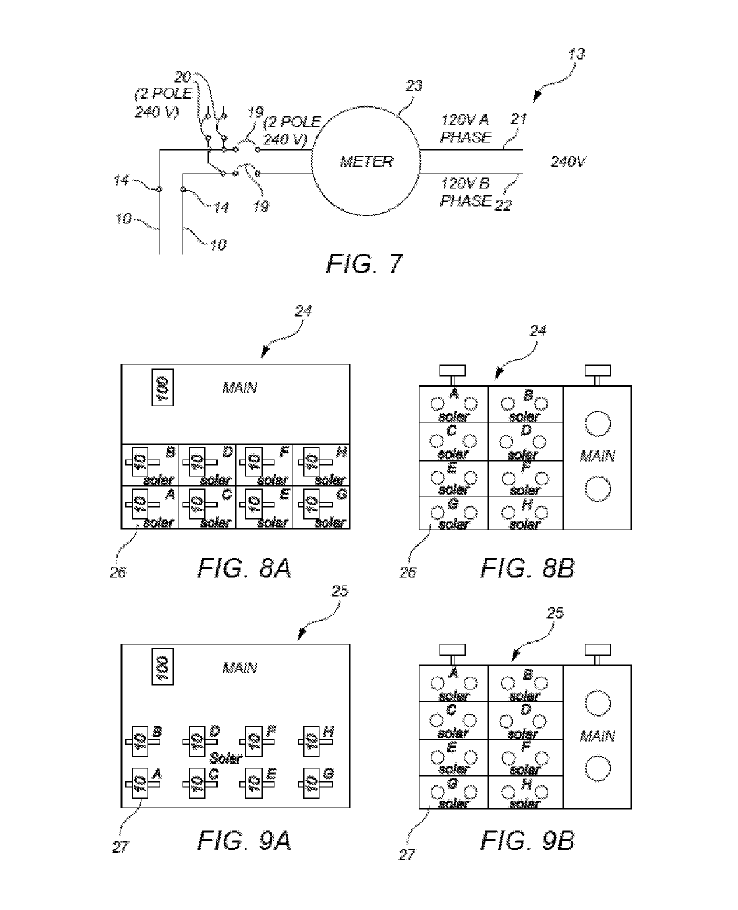

FIG. 7 illustrates a preferred alternative embodiment of the invention. Specifically, the illustration provides incoming power from the utility 13 in two, 120-volt phases, A and B, 21, 22, with a total of 240 volts entering from the utility. The power from the power grid enters home or building via a power meter 23. An alternative energy circuit breaker 20 comprising a 2-pole 240-volt breaker is tapped in parallel with the main circuit breaker with the parallel tap disposed between the main two-pole, 240-volt circuit breaker 19 (i.e., main circuit breaker) and the bus bars 10 and bus bar connection points 14. The alternative energy circuit breaker is connected to and manages power generated from an alternative energy source such as for example, a solar panel assembly, wind turbines or other alternative energy equipment as known in the art. Accordingly, power generated by the alternative energy source, when being directed to the power grid, bypasses the bus bars of the main circuit panel entirely. In times when the home, building or structure require power, electricity generated by the alternative energy source is directed through the bus bars and sent on to the sub breakers of the home, building or structure.

FIG. 8a illustrates the invention that includes a main circuit breaker 24 rated at for example, 100 amps and also sub breakers 26 of the invention. As shown, the main circuit breaker is configured with several sub breakers 26 that are interchangeable. Accordingly, sub breakers of the invention can be replaced and interchanged with other sub breakers rated at either higher or lower amperage. For example, in the event a home owner wishes to upgrade the alternative energy capability of the owner's home the owner may replace a lower amperage sub breaker with a higher rated sub breaker in order to accommodate the additional load on the main panel. FIG. 8b is a side perspective of the main circuit breaker 24 and several sub breakers 26 of the invention. The illustration shows the manner in which the main circuit breaker is configured with interchangeable sub breakers and also shows the terminal connections of the main and sub breakers.

FIG. 9a illustrates the invention that includes a main circuit breaker 25 rated at for example, 100 amps and also sub breakers 27 of the invention. As shown, the main circuit breaker is configured with several sub breakers 27 that are fixed. Accordingly, a homeowner can select the fixed sub breakers if no upgrades of alternative energy sources are anticipated in the future. FIG. 8b is a side perspective of the main circuit breaker 24 and several sub breakers 26 of the invention. The illustration shows the manner in which the main circuit breaker is configured with fixed sub breakers and also shows the terminal connection points.

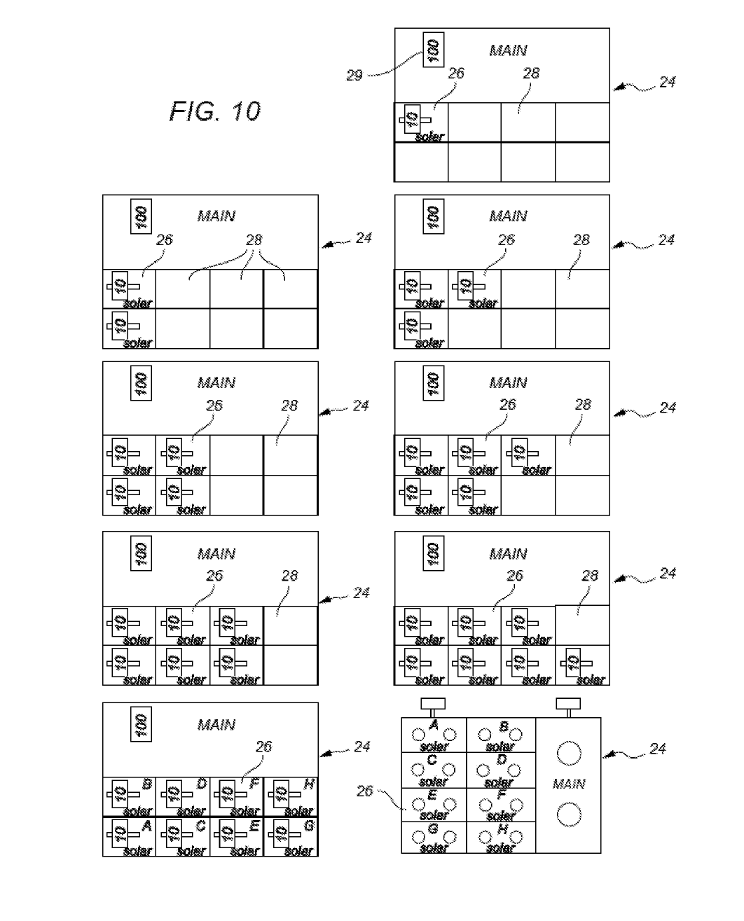

FIG. 10 illustrates several embodiments of the interchangeable main circuit breaker system 24. The main circuit breaker includes a main circuit breaker 29 and one or more sub breakers 26 that can be replaced or removed. As shown, the main circuit breaker system can be configured with one or several sub breakers to accommodate increasing alternative energy sources that are installed in a home, building or structure. Also provided is a side view perspective of the main circuit breaker system 24 that incorporates interchangeable sub breakers. In particular, the perspective depicts the main circuit breaker, numerous sub breakers and the terminal connection points of the main circuit breaker system.

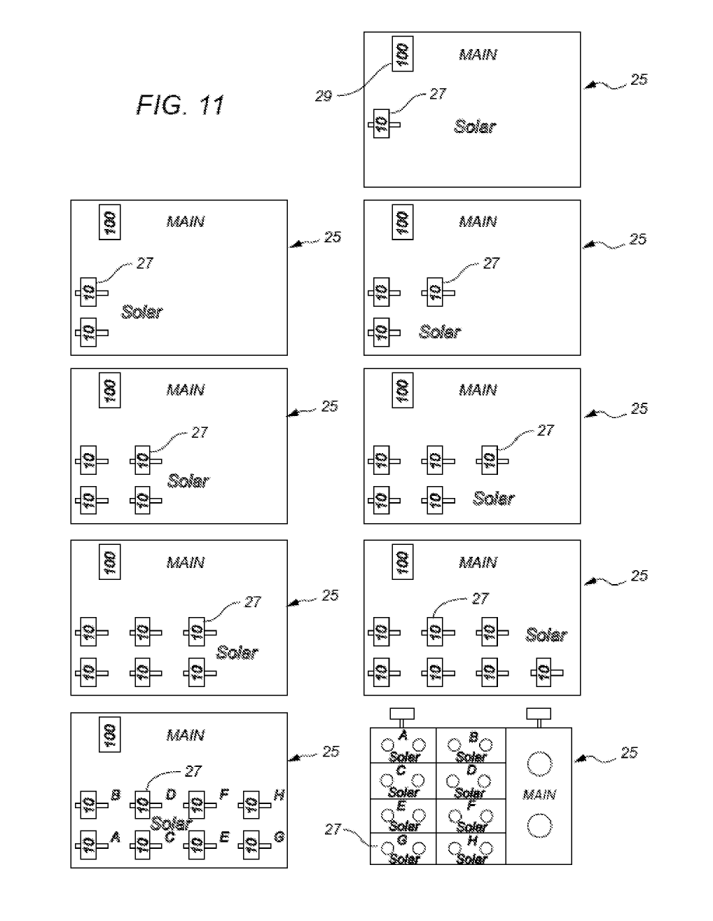

FIG. 11 illustrates several embodiments of the fixed main circuit breaker system 25. The main circuit breaker includes a main circuit breaker 29 and one or more sub breakers 27 that are fixed in place and cannot be replaced or removed. As shown, the main circuit breaker system can be configured with one or several sub breakers to accommodate increasing alternative energy sources that are installed in a home, building or structure. Also provided is a side view perspective of the main circuit breaker system 24 that incorporates fixed sub breakers. In particular, the perspective depicts the main circuit breaker, numerous sub breakers and the terminal connection points of the main circuit breaker system.

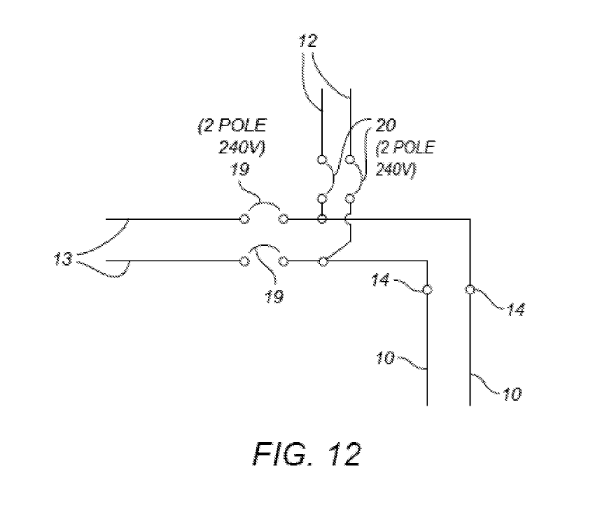

FIG. 12 illustrates a general schematic of the preferred embodiment of the invention. Specifically, power in from the utility 13 enters in two phases of 120 volts each and is delivered to the main circuit breaker 19 (two-pole, 240 volt circuit breaker). Power generated (i.e., backfed power) by an alternative energy source 12 is transferred to a two-pole, 240-volt back feed circuit breaker, that circuit breaker comprising the back feed circuit breaker 20 of the invention. The back feed circuit breaker is connected in parallel tap with the main circuit breaker, wherein the parallel tap is disposed between the main circuit breaker and the bus bars 10 of the main circuit breaker, prior to the point where the bus bars are connected to the main circuit breaker 14. Accordingly, excess power generated by the alternative energy source bypasses the bus bars of the main circuit breaker, thereby maintaining compliance with NEC regulations.

To manufacture the circuit breaker invention, materials and methods known in the art are employed and are envisioned within the scope of the present invention. Certain advantages can be obtained in utilizing the present invention. Foremost, the invention allows a user to save significant time and expense associated with installation of alternative energy devices including but not limited to solar panels, wind turbines and other electricity generating technologies. The invention does so by enabling a home or building owner to install the invention during construction of the structure, even during instances in which alternative energy devices are not installed in the structure, and to install electric generating technologies either during construction of the structure or years after construction has taken place. Accordingly, the present invention is capable of replacing all existing main panels installed in freestanding structures as well as in all future home and building construction.

Benefits of the present invention over the prior art also include back feeding excess energy to the grid for overall use by the public and decrease of electrical rates to the homeowner. Further, the invention encourages the installation of alternative energy technologies including solar panels, wind turbines, as well as any other resource conserving electric generating technology, even those as yet undiscovered in the art.

Although the invention has been described with reference to the above examples, it will be understood that modifications and variations are encompassed within the spirit and scope of the invention. Accordingly, the invention is limited only by the following claims.

What is claimed is:

1. A back feed system comprising, a main service panel wherein said main service panel comprises a main circuit breaker, a back feed circuit breaker and one or more bus bars wherein, said back feed circuit breaker is configured in parallel tap with said main circuit breaker wherein said parallel tap is disposed between said main circuit breaker and said one or more bus bars wherein, said back feed circuit breaker is also connected to an alternative energy source, wherein said alternative energy source generates electricity, said electricity comprising backfed power, wherein said alternative energy source delivers said backfed power to said back feed circuit breaker wherein, said backfed power is then delivered by said back feed circuit breaker by parallel tap to said main circuit breaker, wherein said backfed power is delivered to a utility power grid wherein, said backfed power bypasses said one or more bus bars and said bus bars do not form any portion of the circuit with said backfed power or alternatively, during times of energy need, said backfed power is delivered via said parallel tap to said one or more bus bars wherein said backfed power is thereafter delivered to a structure in order to power electrical components installed within said structure.

2. The back feed system of claim 1 wherein, said back feed circuit breaker is configured in parallel tap with said main circuit breaker wherein, said parallel tap is disposed between a utility meter and said main circuit breaker wherein said backfed power is delivered to a utility power grid wherein said backfed power bypasses said one or more bus bars and said bus bars do not form any portion of the circuit with said backfed power or alternatively, during times of energy need, said backfed power is delivered to said one or more bus bars wherein said backfed power is thereafter delivered to a structure in order to power electrical components installed within said structure.

3. The back feed system of claim 2 wherein said main circuit breaker is connected to one or more sub breakers.

4. The back feed system of claim 3 wherein said one or more sub breakers are interchangeable and can be either removed or replaced.

5. The back feed system of claim 3 wherein said one or more sub breakers are fixed and can neither be removed or replaced.

6. The back feed system of claim 2 wherein said back feed system comprises a one-phase, two-phase or three-phase electrical system and further comprising wiring lugs for each of said phases.

7. The back feed system of claim 2 wherein said main circuit breaker is either a single or double pole circuit breaker.

8. The back feed system of claim 2 wherein said parallel tap is alternatively a “T” tap.

9. The back feed system of claim 2 further comprising one or more back feed circuit breakers.

10. The back feed system of claim 2 wherein said alternative energy source comprises solar panels, wind turbines, hydroelectric generating equipment and gas powered generators.

11. A method of back feeding power to a utility power grid, wherein said power is generated by an alternative energy source said method comprising the steps of installing a back feed system wherein said back feed system comprises a main circuit breaker, a back feed circuit breaker and one or more bus bars and connecting said back feed circuit breaker to an alternative energy source capable of generating electrical power wherein said electrical power comprises backfed power and configuring said back feed circuit breaker in parallel tap with said main circuit breaker, wherein said parallel tap is disposed between said main circuit breaker and said one or more bus bars, wherein said backfed power, when generated by said alternative energy source, is delivered to a utility power grid wherein said backfed power bypasses said one or more bus bars, and said bus bars do not form any portion of the circuit with said backfed power.

12. The method of claim 11 wherein, during times of energy need, said backfed power is delivered to said one or more bus bars then delivered to a structure that requires said backfed power.

13. The method of claim 12 wherein, said back feed circuit breaker is connected in parallel tap with said main circuit breaker wherein, said parallel tap is configured to be disposed between a utility meter connected to a utility power grid and said main circuit breaker wherein said backfed power is delivered to said utility power grid and said backfed power bypasses said one or more bus bars and said bus bars do not form any portion of the circuit with said backfed power and alternatively, during times of energy need, said backfed power is delivered to said one or more bus bars then delivered to a structure that requires said backfed power.

14. The method of claim 12 wherein said main circuit breaker further comprises interchangeable or fixed sub breakers.

15. The method of claim 12 wherein said parallel tap is controlled by said main circuit breaker and said backfed power is delivered to said utility power grid.

16. The method of claim 12 wherein said parallel tap is not controlled by said main circuit breaker and said backfed power is delivered to said utility power grid.

17. The method of claim 12 wherein said one or more bus bars are clamped by means of a securing mechanism to one or more hot lines of said main circuit breaker so to form a secure and direct connection.

18. The method of claim 12 wherein said back feed system comprises a one-phase, two-phase or three-phase electrical system and further comprising wiring lugs for each of said phases.

19. The method of claim 12 wherein said main circuit breaker is configured to be connected to one or more sub breakers.

20. The method of claim 12 wherein said main circuit breaker is configured either with a single or double pole circuit breaker.
